(19) United States
(12) Patent Application Publication
(10) Pub. No.: US 2013/0212125 A1
(43) Pub. Date: Aug. 15, 2013

(54) BIOINFORMATICS SEARCH TOOL SYSTEM FOR RETRIEVING AND SUMMARIZING GENOTYPIC AND PHENOTYPIC DATA FOR DIAGNOSING PATIENTS

(71) Applicants: University of Miami, (US); The Board of Regents of the University of Oklahoma, (US)

(72) Inventors: Klaas Jan Johan Wierenga, Oklahoma City, OK (US); Zhijie Jiang, Fort Lauderdale, FL (US)

(73) Assignees: The Board of Regents of the University of Oklahoma, Norman, OK (US); University of Miami, Miami, FL (US)

(21) Appl. No.: 13/749,390

(22) Filed: Jan. 24, 2013

Related U.S. Application Data
(60) Provisional application No. 61/590,223, filed on Jan. 24, 2012.

(51) Int. Cl. G06F 17/30

(52) U.S. Cl. CPC G06F 17/30424
USPC 707/769

(57) ABSTRACT

A computer system having a processor, non-transitory memory and a communication system is described. The communication system is coupled to a network and communicates with one or more genetic databases using an internet protocol. The non-transitory memory stores processor executable code to cause the processor to (1) receive data indicative of genetic array data of a patient via the communication system, (2) conduct, via the communication system and the network, at least one query of one or more genetic databases of genotypic data and phenotypic data using the data indicative of patient genetic data and phenotypic data, and (3) provide results of the at least one query to provide a clinical synopsis of the patient.

### INCORPORATION BY REFERENCE

The present patent application hereby incorporates by reference the provisional patent application identified by U.S. Ser. No. 61/590,223, filed on Jan. 24, 2012 and titled “Bioinformatics Search Tool System for Retrieving and Summarizing Genotypic and Phenotypic Data for Diagnosing Patients.”

### BACKGROUND

Many diseases are passed genetically from parent to offspring. Some of the diseases known to be genetically passed from parent to offspring are cystic fibrosis, alpha-1-antitrypsin deficiency, fragile X Syndrome, inherited thrombophilias, hereditary hemochromatosis, sickle cell disease, severe combined immunodeficiency, and others. There are more than 1,000 genetic disorders for which testing is available. Most disorders are rare, and many genetic tests are expensive and complex. For this reason, family history, ancestry, and medical history all play a role for medical professionals to determine appropriate testing for a patient during potential diagnosis of a disease. As the rarity of a disease increases, so does the difficulty in diagnosing the patient with the disease. Similarly, as the rarity of a disease increases, the time required to accurately diagnose the disease also increases. Therefore, medical professionals need tools by which they can quickly and efficiently narrow the list of possible genetic disorders for more effective and accurate diagnosis of patient disease.

Deoxyribonucleic acid (DNA) is the basic building block of life. DNA may be defined as any of various nucleic acids that are usually the molecular basis of heredity, are constructed of a double helix held together by hydrogen bonds between purine and pyrimidine bases which project inward from two chains containing alternate links of deoxyribose and phosphate. DNA is a nucleic acid that contains genetic instructions which are the basis of the development and function of most life forms, in this case humans. DNA is composed of molecules called nucleotides that when joined together form the structure of DNA. In DNA, nucleic acids are made from nucleotide constructions. There are four basic nucleotide structures, adenine (A), guanine (G), thymine (T), and cytosine (C). A always pairs with T, and C always pairs with G. These pairings of complementary bases Ac [symbol] T and C [symbol] G within a DNA strand are base pairs. DNA is further packaged with histones, in a larger scale, into a structure called a chromosome. A chromosome is a single piece of supercoiled DNA which contains, among other elements, genetic information, such as genes, regulatory elements, and transportable elements. A human genome contains 22 autosomes and a pair of sex chromosome (X and Y in male, and two Xs in female).

A gene is the genetic information unit of heredity in an individual consisting of a sequence of DNA and determines a particular characteristic of an organism. A gene can be defined as a locatable or fixed region of genomic sequence, corresponding to a unit of inheritance, which is associated with regulatory regions, transcribed regions, and or other functional sequence regions. Genes contain information for regulating, building and maintaining a human's cells and also pass genetic traits to offspring. All humans have genes which correspond to various traits, some of which are visible (phenotype), as in the case of eye or hair color, and some are not readily visible (genotype). A genotype is the genetic make-up of an organism or group of organisms with reference to a single trait, set of traits, or an entire complex of traits. A phenotype is the appearance of an organism resulting from the interaction of the genotype and the environment, such as eye or hair color.

A gene can have a variation or mutation, which is called an allele. An allele is one of two or more forms of a gene that have the same relative position on homologous chromosomes and are responsible for alternative characteristics. Humans are diploid, meaning they have two sets of chromosomes. In turn, this means they may have two variations of any given gene, alleles. Homologous chromosomes are chromosome pairs which share, among other things, the same length and contain genes for the same characteristics at corresponding loci, alleles. A locus, the singular of loci, is the specific location of a gene on a chromosome. Diploid organisms have one copy of each gene, therefore one allele, on each chromosome at corresponding loci. Each individual inherits two copies of DNA, one maternal and one paternal. If the alleles are the same, sharing the same mutation or lack thereof, they are referred to as homozygous. If the alleles are different, where one is mutated and one is not, they are referred to as heterozygous.

A more specific version of an allele may result from single-nucleotide polymorphism (SNP). A SNP is a genetic variation in a DNA sequence that occurs when a single nucleotide in a genome is altered. It is not rare for several SNPs to be present in a single gene. In order to be considered as a SNP, the single base change in a DNA sequence is observed in a significant portion, more than 1 percent, of a large population. SNPs are found every 100 to 300 bases along the 3 billion base human genome. Some SNPs are not inherited independently, but rather linked in block pattern on alleles. A block pattern inheritance on an allele is referred to as a haplotype. Haplotypes may be transmitted without variation, allowing haplotypes to be identified by relatively few SNPs within a given haplotype. Allele and SNP variations in the DNA sequence may be harmless, latent and only apparent under certain conditions, or associated with diseases and disorders. Genetic variations in SNPs may be determined through SNP genotyping. Genotyping is a method of determining differences in the genotype of an individual by examining the individual's DNA sequence and comparing it to a reference sequence. Genotyping can also be used to reveal the alleles inherited from an individual's parents. In order to reveal alleles in DNA, genotyping requires the use of biological assays. An assay is a testing procedure for measuring the amount of a substance in a sample. SNP genotyping is used to measure the genetic variations due to SNPs between members of a species.

As used herein, the term SNP includes all single base variations, including nucleotide insertions and deletions in addition to single nucleotide substitutions. The inheritance patterns of most common diseases are complex, indicating that the diseases are probably caused by mutations in one or more genes and/or through interactions between genes and the individual's environment. Some diseases are autosomal recessive (AR) diseases. AR diseases occur when two copies of an allele associated with an AR disease are passed to an individual. AR diseases include cystic fibrosis, sickle-cell disease, Tay-Sachs disease, Niemann-Pick disease, spinal muscular atrophy, etc. AR diseases are often rare because the probability of requiring inheritance of the identical recessive disease carrying gene from both parents is extremely rare. The offspring of consanguineous relationships are at greater risk of AR diseases, because of the increased risk of homozygosity due to consanguinity (a shared common ancestor)

SNPs are well-suited for identifying genotypes that may predispose an individual to develop a disease condition. Since SNPs located in genes may directly affect gene function, protein structure or expression levels, they may serve as diagnostic markers. Implementing SNP genotyping as a tool in diagnosis requires the availability of databases comprising high quality annotation data on known SNPs, as well as clinical annotation of genes where SNPs locate. As the amount of known genetic sequence information increases, researchers and practitioners will have increasing amounts of information with which to study and diagnose individuals and diseases. However, as the volume of information increases it is increasingly important to be able to appropriately associate the data to employ it for study and diagnosis.

Current genotyping techniques known in the art can accurately genotype hundreds of thousands of SNPs in a genetic sample in parallel to provide a molecular fingerprint of the genetic sample. Many genotyping techniques are sensitive enough to analyze a SNP profile to determine if an individual is homozygous or heterozygous for a given gene (i.e. possesses one copy of each allele). The results of this analysis can be used for research and for making diagnostic and therapeutic decisions.

A microarray, one current method of genotyping uses a collection of DNA probes attached to a solid surface. Microarrays can be used to measure the expression levels of many genes simultaneously. Microarray platforms, capable of genotyping multiple SNPs, rapidly identify susceptible genes for complex phenotypes. Microarrays have typically been used in a whole genome association approach, in which each known SNP is examined. Recent methods identify genetic loci influencing heritable phenotype by identifying long runs of consecutive SNP loci that are homozygous. These long segments of consecutive homozygous SNP loci are called runs of homozygosity (ROH). A ROH is a series of consecutive known SNP positions that are homozygous in the genome of an individual, often denoting consanguinity within the individual's lineage. ROH have been linked to diseases such as certain forms of cancer, schizophrenia, and others.

Computer based methods and systems for searching and accessing information from databases are well known in the art in biological research. However, a gene expression array and a SNP array are designed for different purposes and analyzed by different methods. A conventional computer system may allow practitioners to access and search genetic databases thoroughly and effectively. Genetic databases often store information in relational format. Relational databases support operations defined by relational algebra. Practitioners require advanced quantitative analyses, database searches and comparisons, and algorithms to explore relationships between particular gene sequences and traits, diseases, behaviors, and phenotypes. Processing larger volume of biological data with computer-based technologies in this way is referred to as bioinformatics.

Most commercially available bioinformatics systems perform functional analysis using a single information source or through limited search parameters. Often these search parameters are limited to locating genes, for instance within a ROH, by a coordinate system. Once the genes within the ROH are located, a researcher or practitioner may query a database such as the Online Mendelian Inheritance in Man (OMIM) database to determine information about the genes regarding the relationship between genotype and phenotype. Using the information resulting from an OMIM database query, a researcher or practitioner will then need to determine, often using a separate database, which genes within the ROH are related to diseases. Often, a researcher or practitioner will then need to consult another database to determine which if any of the disease associated genes are also AR disease associated genes. Finally, in order to diagnose a rare disorder in an individual presenting with a disease and a ROH, the practitioner may then need to compile by hand information from multiple databases and from the individual's clinical synopsis in order to determine to attempt a diagnosis. Through this process, the researcher or practitioner may not collect all the pertinent data between each of the varying databases and therefore misdiagnose based on compiling voluminous information from varying sources. There is a need, therefore, for a system which, through a series of queries, can narrow the information from multiple databases in an efficient and timely fashion. If this cannot be accomplished the practitioner is not likely to pursue a timely and appropriate approach.

### BRIEF DESCRIPTION OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a schematic diagram of an embodiment of a bioinformatics search tool system according to the instant inventive concept(s).

FIG. 2 is a block diagram of an embodiment of a memory according to the instant inventive concept(s).

FIG. 3 is a logic flow diagram of an exemplary embodiment of a method of registering users according to the instant inventive concept(s).

FIG. 4 is a logic flow diagram of an exemplary embodiment of a series of sequential queries according to the instant inventive concepts.

FIG. 5 is an exemplary embodiment of a logon page according to the instant inventive concept(s).

FIG. 6 is an exemplary embodiment of a registration page according to the instant inventive concepts.

FIG. 7 is an exemplary embodiment of a query page according to the instant inventive concepts

FIG. 7A is an exemplary embodiment of a folded HPO phenotype hierarchy page according to the instant inventive concepts.

FIG. 7B is an exemplary embodiment of the partial of an open HPO phenotype hierarchy page according to the instant inventive concepts.

FIG. 7C is an exemplary embodiment of an open HPO phenotype hierarchy page with the selected HPO ID query string in the HPO query box according to the instant incentive concepts.

FIG. 7D is another view of the exemplary embodiment of the query page showing the query ROH and query HPO ID according to the instant inventive concepts.

FIG. 8 is an exemplary embodiment of a results page according to the instant inventive concepts in which results are shown in multiple sections.

### DETAILED DESCRIPTION OF THE INVENTION

Before explaining at least one embodiment of the inventive concept(s) disclosed herein in detail, it is to be understood that the inventive concept(s) is not limited in its application to the details of construction and the arrangement of the components or steps or methodologies set forth in the following description or illustrated in the drawings. The inventive concept(s) disclosed herein is capable of other embodiments or of being practiced or carried out in various ways. Also, it is to be understood that the phraseology and terminology employed herein is for the purpose of description and should not be regarded as limiting the inventive concept(s) disclosed and claimed herein in any way.

In the following detailed description of embodiments of the inventive concept(s), numerous specific details are set forth in order to provide a more thorough understanding of the inventive concept(s). However, it will be apparent to one of ordinary skill in the art that the inventive concept(s) within the disclosure may be practiced without these specific details. In other instances, well-known features have not been described in detail to avoid unnecessarily complicating the instant disclosure.

As used herein, the terms “network-based,” “cloud-based” and any variations thereof, are intended to cover the provision of configurable computational resources on demand via interfacing with a computer network, with software and/or data at least partially located on the computer network, by pooling the processing power of two or more networked processors, for example.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept(s). This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

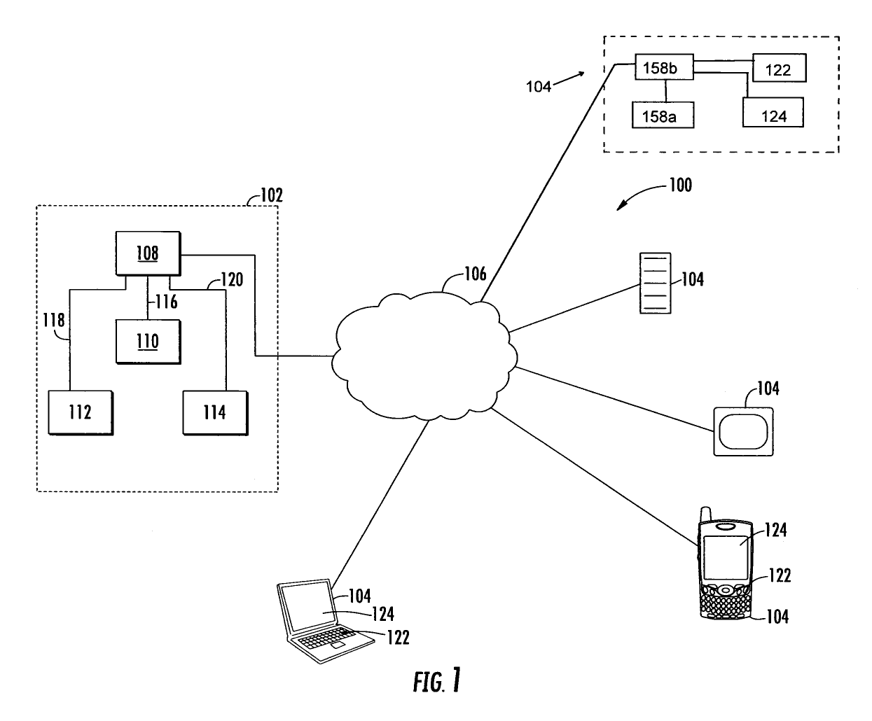

Referring now to FIG. 1, shown therein is an exemplary embodiment of a bioinformatics search tool system 100 according to the instant disclosure. The bioinformatics search tool system 100 comprises one or more host systems 102 capable of interfacing and/or communicating with one or more user terminals 104 over a network 106. In general, the bioinformatics search tool system 100 is used to retrieve and summarize genetic data obtained on SNP array as well as oligonucleotide array comparative genomic hybridization for clinical practice. The user terminals 104 can be located at a point of diagnosis such as a clinic or a reading center where genetic information from one or more patients is collected and/or analyzed. The one or more host systems 102 are programmed to receive information from the user terminals 104 and to conduct an automated sequence of queries so as to locate gene mutations specific to the patient which may cause a disease or a disorder. The one or more host system 102 may be implemented as a website having a web server generating hypertext markup language pages, for example, that can be rendered by browser programs running on the user terminals 104. The term “page” as used herein refers to computer executable logic that can be rendered into visual and/or audio information perceivable by a user, and are typically created using hypertext markup language, although other types of programming languages could be used, such as hypertext markup language 2, PERL or the like.

In general, the bioinformatics search tool system 100 works on the principle that (1) SNP arrays, for example, may identify runs of homozygosity in patients, especially in patients whose parents are consanguineous, and (2) the disorder of the patient is likely caused by homozygosity by descent. However, in many such cases, the identification of the gene mutations which cause the disorder is a difficult task for the clinician. Due to the nature and volume of the data involved in analyzing runs of homozygosity manually using genomic databases including UCSC Genome Browser, OMIM and NCBI databases, etc., such manual analysis is time consuming, and likely incomplete. The same applies to microdeletions and (to a certain extent) microduplications identified by oligonucleotide arrays. The bioinformatics search tool system 100 preferably provides a report having a complete list of all known genes, all known disease-causing genes in those ROHs, microdeletions and microduplications, and provides clinical annotation on gene function(s) as well as phenotypic information such as disorders/diseases caused by gene dysfunctions. The bioinformatics search tool system 100 relieves physicians from laborious search work, and enables the physician to focus on more critical work to match the patient's key signs and symptoms with the gene and disease list provided, to target further investigations, ultimately to reach a clinical diagnosis, and possibly meaningful intervention more timely.

The bioinformatics search tool system 100 preferably automatically cross-links multiple genetic databases and provides pertinent information for disease candidate genes. In one embodiment, as discussed below, the bioinformatics search tool system 100 (1) receives runs of homozygosity within the genetic array data, (2) receives phenotypic data related to physical characteristics of a patient potentially related to a disease, (3) stores data indicative of the runs of homozygosity and phenotypic data on a non-transient memory, and (4) conducts at least one query. The at least one query may use the stored data indicative of runs of homozygosity and phenotypic data to query a first genetic database including genotypic and phenotypic information concerning genes and how the genes affect diseases/disorders. Additionally, the at least one query may use the stored data indicative of the runs of homozygosity to query a first genetic database including genotypic information concerning genes, without the use of the stored phenotypic data. The result of the at least one query is stored on a non-transient memory. The at least one query may include multiple queries on one or more genetic databases in order to narrow the results of the at least one query.

The bioinformatics search tool system 100 is useful for analyzing genotypic information and phenotypic information beginning with runs of homozygosity, microdeletions, and microduplications. However, it is believed that the bioinformatics search tool system 100 is less useful for analyzing genotypic information and phenotypic information beginning with microduplications. The bioinformatics search tool system 100 may retrieve and summarize the genetic information from multiple databases, thus the accuracy of the result is influenced by the accuracy of the annotation information in these databases.

The bioinformatics search tool system 100 can be implemented in a variety of manners. For example, the one or more host systems 102 comprise one or more processors 108 capable of executing processor executable code, one or more non-transitory memory 110 capable of storing processor executable code and data, an input device 112, and an output device 114, all of which can be partially or completely network-based or cloud-based, and not necessarily located in a single physical location.

The one or more processors 108 can be implemented as a single processor 108 or multiple processors 108 working together to execute the logic described herein. Exemplary embodiments of the one or more processor 108 include a digital signal processor (DSP), a central processing unit (CPU), a field programmable gate array (FPGA), a microprocessor, a multi-core processor, and combinations thereof. The one or more processor 108 is capable of communicating with the one or more memories 110 via a path 116 which can be implemented as a data bus, for example.

The one or more processor 108 is capable of communicating with the input device 112 and the output device 114 via paths 118 and 120, respectively. Paths 118 and 120 may be implemented similarly to, or differently from, path 116. The one or more processor 108 is further capable of interfacing and/or communicating with the one or more user terminals 104 via the network 106, such as by exchanging electronic, digital, and/or optical signals via one or more physical or virtual ports using a network protocol such as TCP/IP, for example. It is to be understood that in certain embodiments using more than one processor 108, the one or more processor(s) 108 may be located remotely from one another, located in the same location, or comprising a unitary multi-core processor (not shown). The one or more processor 108 is capable of reading and/or executing processor executable code and/or creating, manipulating, altering, and storing computer data structures into the one or more memory 110.

The one or more memory 110 stores processor executable code and may be implemented as any conventional non-transitory memory 110, such as random access memory (RAM), a CD-ROM, a hard drive, a solid state drive, a flash drive, a memory card, a DVD-ROM, a floppy disk, an optical drive, and combinations thereof, for example. It is to be understood that while one or more memory 110 is shown located in the same physical location as the host system 102, the one or more memory 110 may be located remotely from the host system 102 and may communicate with the one or more processor 108 via the network 106. Additionally, when more than one memory 110 is used, one or more memory 110 may be located in the same physical location as the host system 102, and one or more memory 110 may be located in a remote physical location from the host system 102. The physical location(s) of the one or more memory 110 can be varied, and the one or more memory 110 may be implemented as a “cloud memory,” i.e. one or more memory 110 which is partially or completely based on or accessed using the network 106.

The input device 112 transmits data to the processor 108, and can be implemented as a keyboard, a mouse, a touch-screen, a camera, a cellular phone, a tablet, a smart phone, a PDA, a microphone, a network adapter, and combinations thereof, for example. The input device 112 may be located in the same physical location as the host system 102, or may be remotely located and/or partially or completely network-based. The input device 112 communicates with the processor 108 via path 118.

The output device 114 transmits information from the processor 108 to a user, such that the information can be perceived by the user. For example, the output device 114 can be implemented as a server, a computer monitor, a cell phone, a tablet, a speaker, a website, a PDA, a fax, a printer, a projector, a laptop monitor, and combinations thereof. The output device 114 can be physically co-located with the host system 102, or can be located remotely from the host system 102, and may be partially or completely network based (e.g. a website). The output device 114 communicates with the processor 108 via the path 120. As used herein the term “user” is not limited to a human, and may comprise a human, a computer, a host system, a smart phone, a tablet, and combinations thereof, for example.

The network 106 preferably permits bi-directional communication of information and/or data between the host system 102 and the user terminals 104. The network 106 may interface with the host system 102 via a network interface (not shown) in a variety of ways. The network interfaces of the user terminals 104 can be wired or wireless network cards in the user terminals 104 and can be implemented in a variety of manners, such as optical and/or electronic interfaces, and may use one or more network topographies and protocols, such as, for example, Ethernet, TCP/IP, circuit switched paths, and combinations thereof. For example, the network 106 can be implemented as the World Wide Web (or Internet), a local area network (LAN), a wide area network (WAN), a metropolitan network, a wireless network, a cellular network, a GSM network, a CDMA network, a 3G network, a 4G network, a satellite network, a radio network, an optical network, a cable network, a public switched telephone network, an Ethernet network, and combinations thereof, and may use a variety of network protocols to permit bi-directional interface and communication of data and/or information between the host system 102 and the one or more user terminals 104.

The one or more user terminals 104 can be implemented, for example, as a personal computer, a smart phone, a tablet, an e-book reader, a laptop computer, a desktop computer, a network-capable handheld device, a server, and combinations thereof. In an exemplary embodiment, the user terminal 104 comprises an input device 122, an output device 124, a processor (not shown), and a web browser capable of accessing a website and/or communicating information and/or data over a network, such as the network 106. As will be understood by persons of ordinary skill in the art, the one or more user terminals 104 may comprise one or more non-transient memories (e.g, random access memory, flash memory and/or a hard disk) comprising processor executable code and/or software applications, for example.

The input device 122 is capable of receiving information input from a user and/or another processor, and transmitting such information to the user terminal 104 and/or to the host system 102. The input device 122, for example, may be implemented as a keyboard, a touch-screen, a mouse, a trackball, a microphone, an infrared port, a slide-out keyboard, a flip-out keyboard, a cell phone, a PDA, a video game controller, a remote control, a network interface, and combinations thereof.

The output device 124 outputs information in a form perceivable by a user and/or readable or executable by another processor. For example, the output device 124 can be a server, a computer monitor, a screen, a touch-screen, a speaker, a website, a TV set, a smart phone, a PDA, a cell phone, a fax machine, a printer, a laptop computer, and combinations thereof. It is to be understood that in some exemplary embodiments, the input device 122 and the output device 124 may be implemented as a single device, such as, for example, a touch-screen or tablet. It is to be further understood that as used herein the term user is not limited to a human being, and may comprise, for example, a computer, a server, a website, a processor, a network interface, a human, a user terminal, a virtual computer, and combinations thereof.

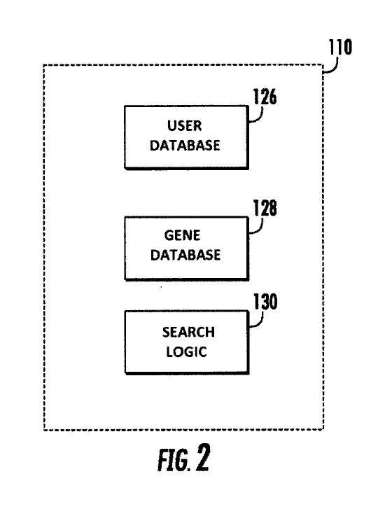

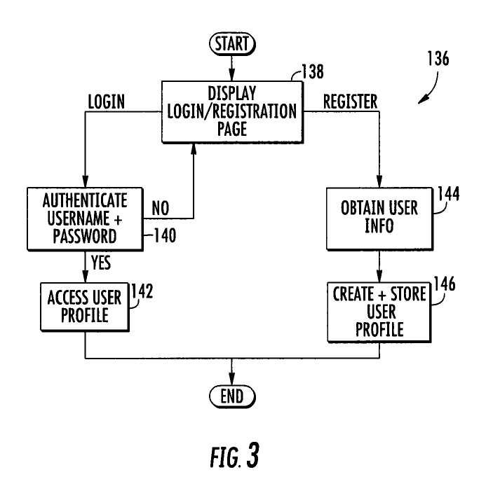

Referring now to FIG. 2, the one or more memory 110 preferably stores processor executable code and/or information comprising a user database 126, one or more gene database(s) 128, and search logic 130. The processor executable code may be written in any suitable programming language, such as PERL, C++, hypertext markup language, and/or Java, for example. The user database 126 and the one or more gene database(s) 128 can be stored as a data structure, such as a relational database and/or one or more data table(s), for example.

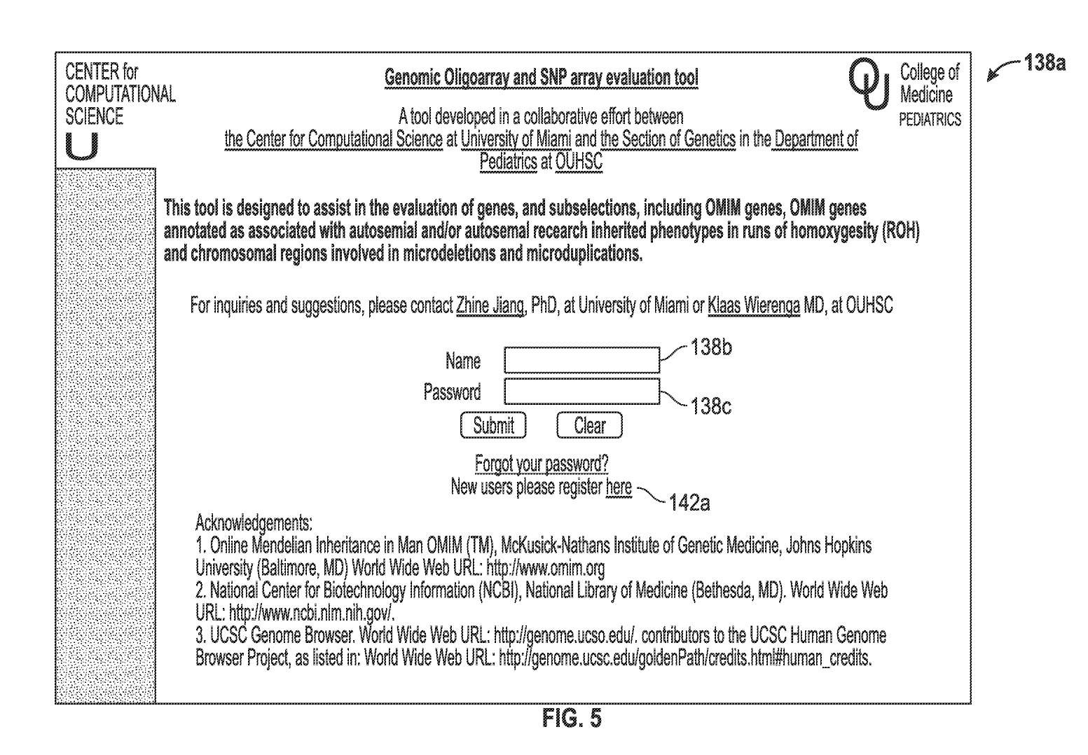

The user database 126 preferably comprises user profile information about users, such as clinicians or physicians, registered with the host system 102. In one embodiment, shown in FIG. 3, one or more users accessing the bioinformatics search tool website of the host system 102 via user terminal 104 can be directed by the processor 108 to a login/registration portion of the website in step 138. An exemplary logon/registration page 138a is depicted in FIG. 5 and will be described in more detail below. If the user has previously registered with the host system 102, the user may be prompted by the processor 108 to provide login credentials (e.g. username and password) into data entry fields 138b and 138c, which allow the processor 108 to authenticate the user against the user database 126 in a step 140.

Each user of the host system 102 preferably has a user profile including information stored in the user database 126. The host system 102 accesses the user profile in a step 142. The user profile may include the following information: demographic information including name, age, address, billing account information, username, password, field of work, experience, and the like. If the user authentication is successful, the user's profile may be accessed by the processor 108. If the user authentication fails, the user may be returned to login/registration page(s), where the user may be prompted for a username and password again. Optionally, the processor 108 may block a user from entering a username and password after a preset number of failed authentication attempts. It is to be understood that the user database 126 may further comprise user profiles for users who have not registered with the host system 102, but who have previously visited or are currently accessing the bioinformatics search tool website maintained by the host system 102, for example.

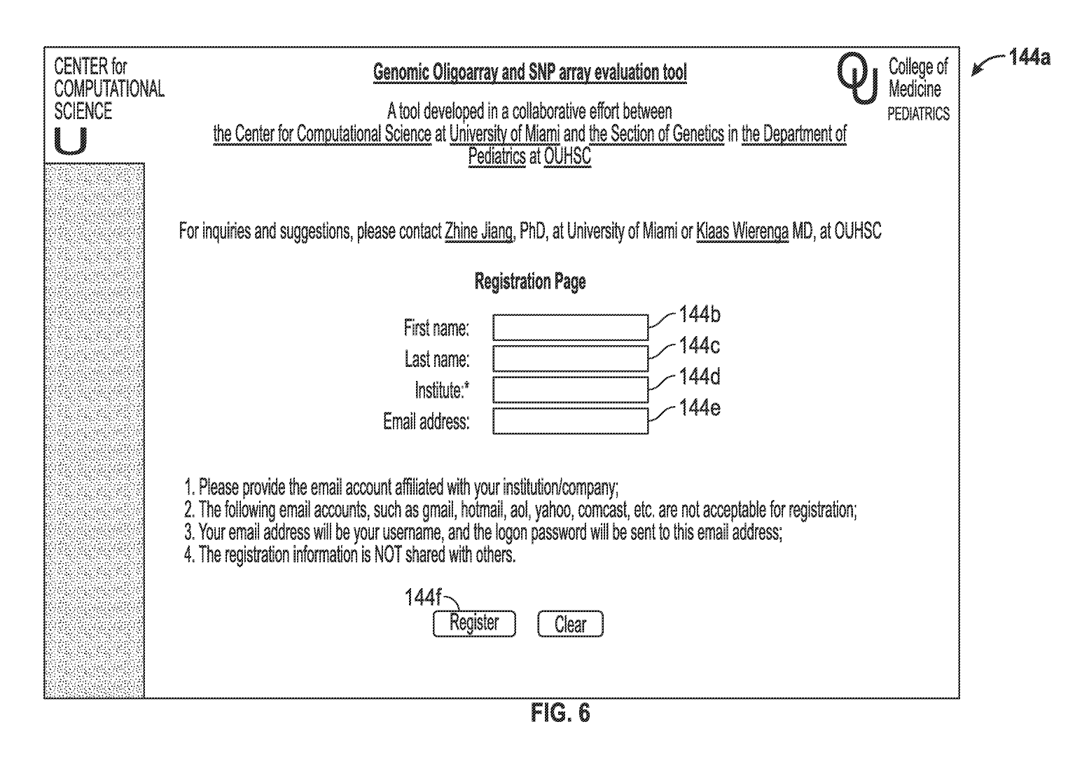

If the user is not registered with the host system 102, the user may select a registration link 142a and be directed to a registration page 144a (see FIG. 6) for registering the user by collecting demographic information, billing account information, shipping address, desired username and password, and other information collected from the user and/or generated by the host system 102 in a step 144. In the step 144, the registration page 144a is provided to the user terminal 104 by the host system 102. The registration page 144a may include data entry fields 144b, 144c, 144d, and 144e for collecting information from the user, such as a first name of the user, a last name of the user, institute name affiliated with the user, and user e-mail address. The registration page 144a may also include logic for making the user e-mail address the user's logon name, as well as other authentication logic. For example, the authentication logic may reject certain user e-mail addresses, such as e-mail addresses provided by gmail, hotmail, aol, yahoo, Comcast, etc. that are not affiliated with a particular institute. Once the information has been provided into the data entry fields 144b-e, for example, the host system 102 can receive a user registration signal indicating that the user desires to set up an account. The user registration signal can be generated by one of the user terminals 104 by clicking on a register button 144f, for example.

In any event, a user profile is created and preferably stored in the user database 126 by the processor 108 in a step 146. The user profile may be stored in the user database 126 and may be provided, or made available to a user in the form of a user account/registration page, depicted in FIG. 6, as will be understood by persons of ordinary skill in the art presented with the instant disclosure.

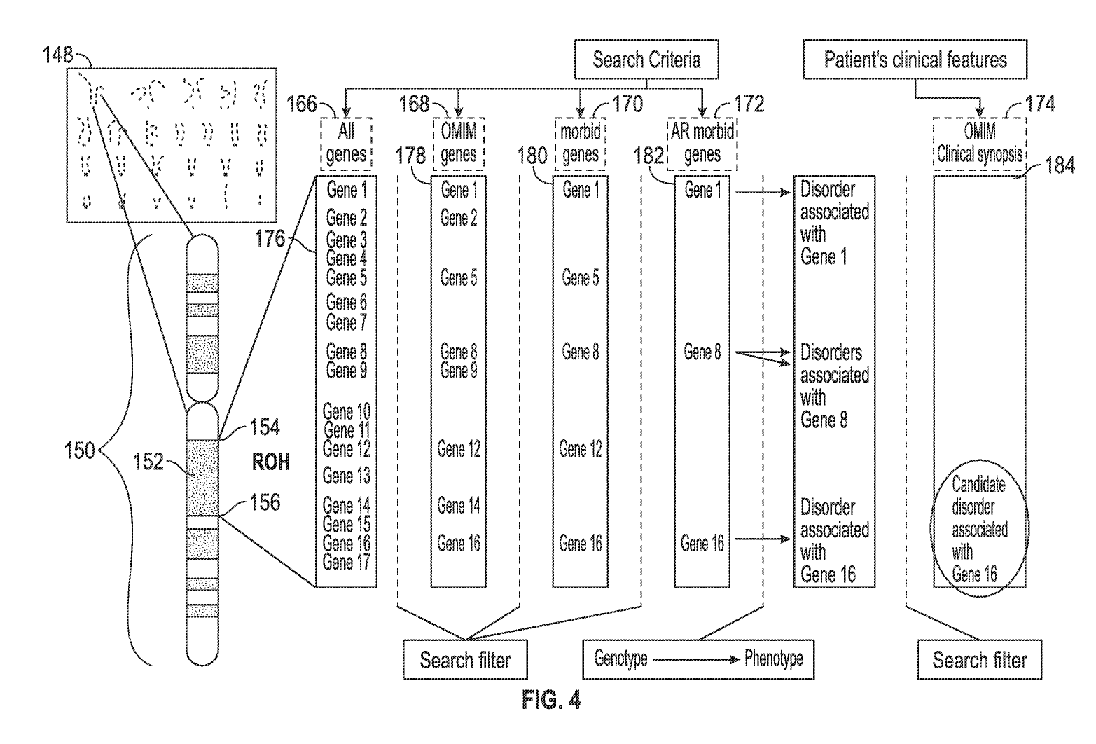

Referring to FIG. 4, an embodiment of the bioinformatics search tool system 100 preferably initially uses human genome data 148. In one embodiment the human genome data 148 is collected from a SNP array, comprising data on detected polymorphisms within a genetic sample of a patient presenting phenotypic indicators possibly relating to a disease. Using the SNP array, a chromosome 150 may be identified from the human genome data 148. Within the chromosome 150, at least one run of homozygosity (ROH) 152 may be identified by data from the SNP array. The at least one ROH 152 may be delimited by at least one first genomic coordinate 154 and at least one second genomic coordinate 156, representing a chromosome range for the at least one ROH 152. The at least one ROH 152 may be stored in a data structure on non-transient memory 158a located in the user terminal 104, for example. The at least one ROH 152 data structure will include the first and second genomic coordinates 154 and 156, respectively, for example. The user terminal 104 may be structured similar to the host system 102, where the user terminal 104 includes a processor 158b, the non-transient memory 158a, an input device 122, and an output device 124.

The user causes the processor 158b to execute processor executable code on the user terminal 104 which determines the genes which fall in the chromosome range specified by the first and second genomic coordinates 154 and 156. The bioinformatics search tool system 100 presents the user with a plurality of search options. Through choosing one of the plurality of search options, the user causes the processor 158b to execute processor executable code on the user terminal 104 to analyze the chromosome region specified by the first and second genomic coordinates 154 and 156, respectively, to determine (1) all known genes located between the first and second genomic coordinates 154 and 156, respectively, (2) all genes within a specific genomic database located between the first and second genomic coordinates 154 and 156, respectively, (3) morbid genes located between the first and second genomic coordinates 154 and 156, respectively, (4) AR morbid genes located between the first and second genomic coordinates 154 and 156, respectively, (5) AD morbid genes located between the first and second genomic coordinates 154 and 154, respectively (not shown), or (6) genes matching to patient's clinical features/symptoms located between the first and second genomic coordinates 154 and 156, respectively.

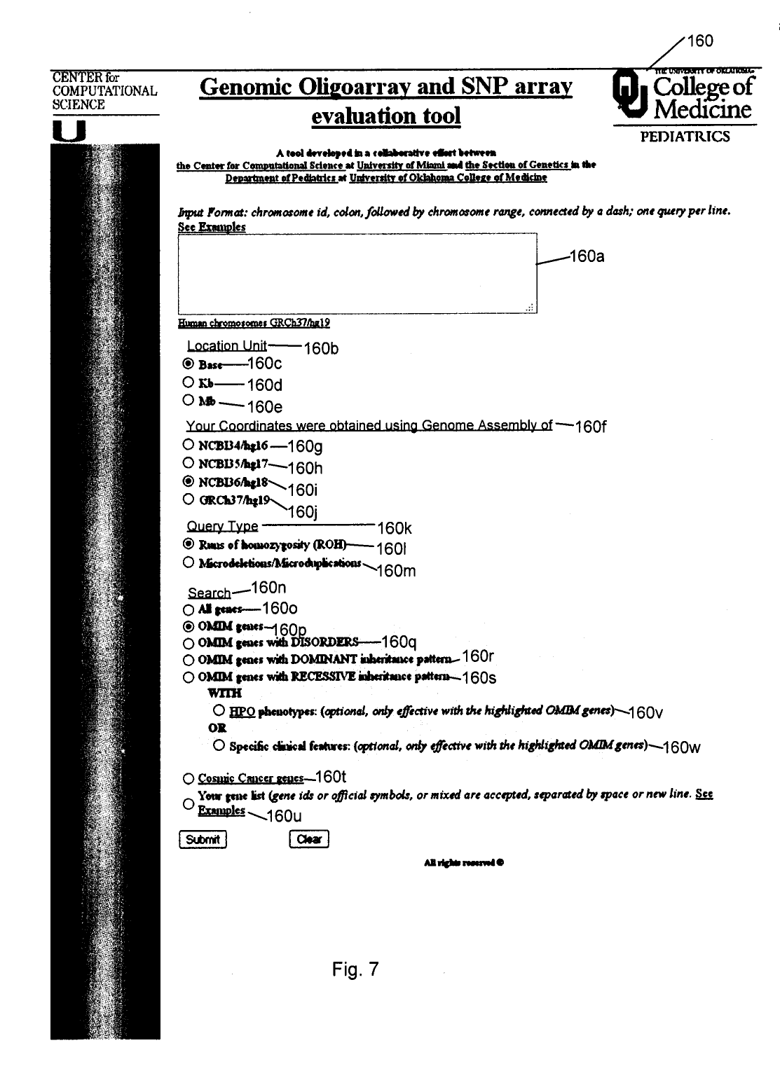

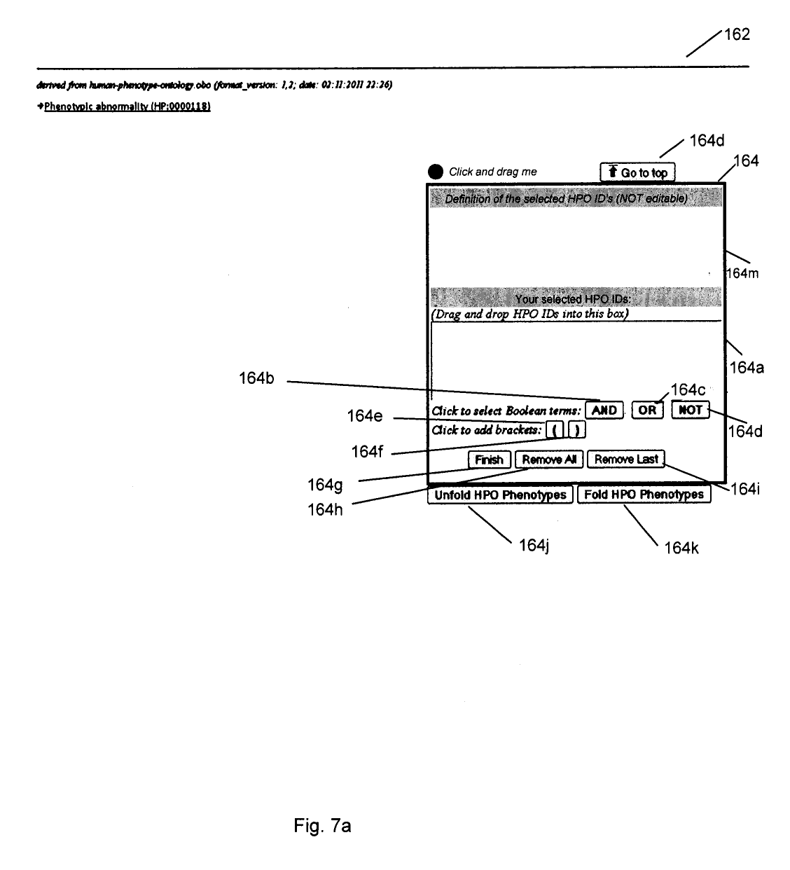

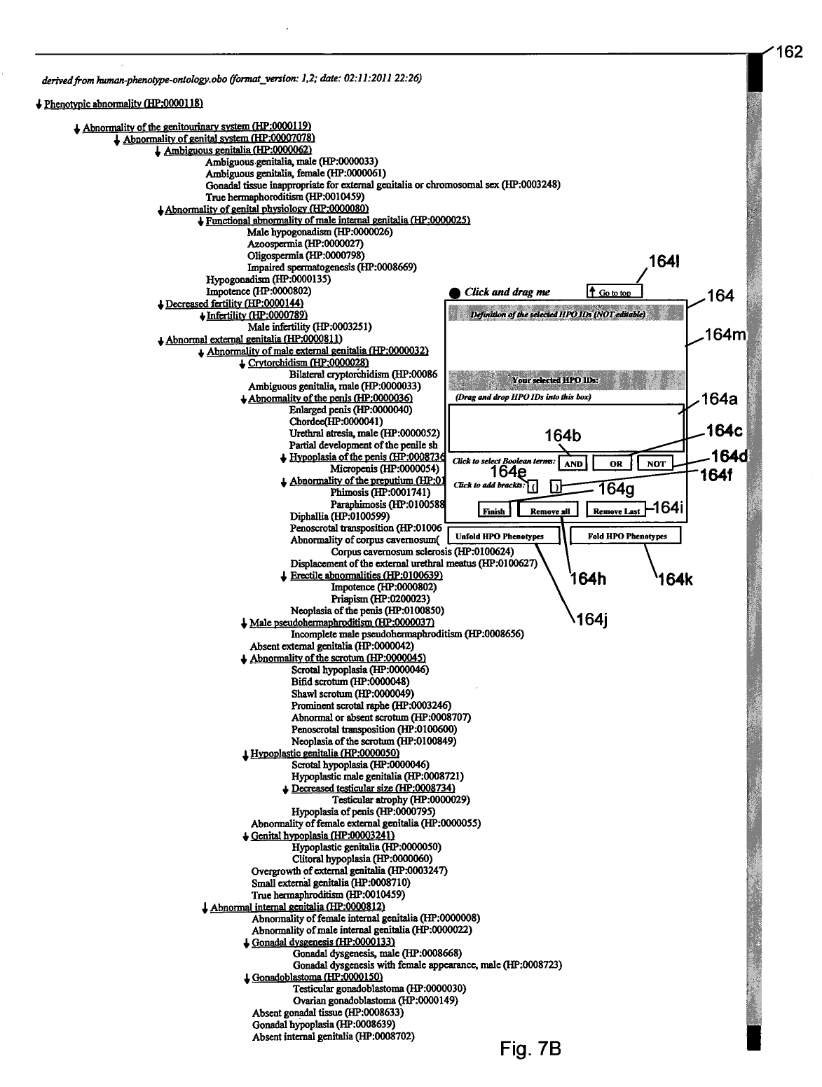

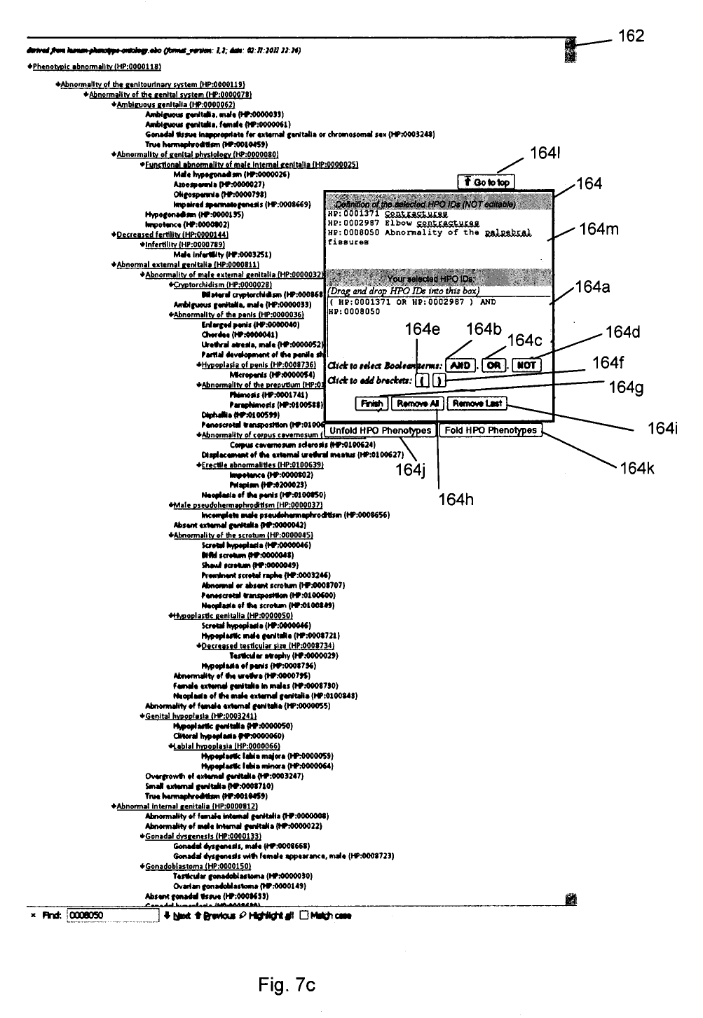

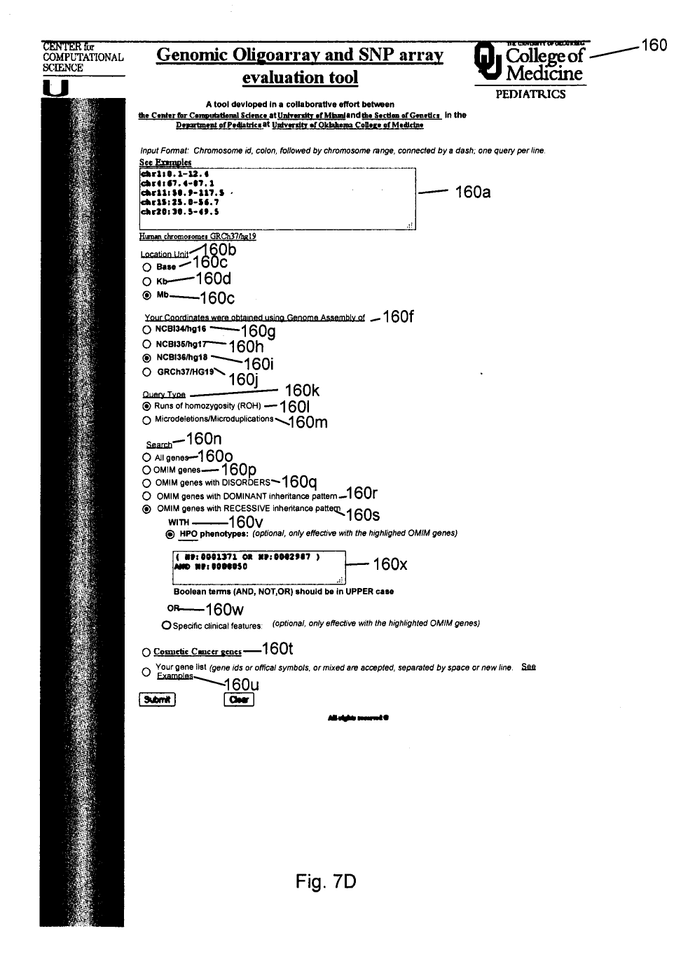

In the embodiment of the bioinformatics search tool 100, shown in FIG. 4, the user may enter the first and second genomic coordinates 154 and 156, respectively, into the bioinformatics search tool. An exemplary bioinformatics search tool website 160 is depicted in FIG. 7. Entering the first and second genomic coordinates 154 and 156, respectively, into the bioinformatics search tool 100, the user may search against any preloaded genetic databases. As depicted in FIG. 7, in one embodiment, the user may enter the first and second genomic coordinates 154 and 156, respectively, into a data entry field 160a. In the embodiment shown in FIG. 7, entering the first and second genomic coordinates 154 and 156, respectively, into the data entry field 160a may be performed by the user entering the information via the input device 122, for example, by typing the information into the data entry field 160a, by cut/copy and paste operation, by signaling the processor 158b to automatically fill the data entry field 160a with the information from a given file, or any other appropriate means.

As shown in FIG. 7, the user then selects a location unit 160b for the search query entered into the data entry field 160a. The location unit 160b, in the embodiment shown in FIG. 7, is composed of three radial buttons. In the embodiment shown in FIG. 7, the user may select the base radial button 160c, the Kb radial button 160d, or the Mb radial button 160e. The base radial button 160c denotes the base pair location unit where one base pair corresponds to about 3.4 angstrom of length along the DNA strand. The Kb radial button 160d denotes the kilo base pair unit which is a unit of length for DNA fragments equal to 1,000 base pairs. The Mb radial button 160e denotes the mega base pairs unit which is a unit of length for DNA fragments equal to 1,000,000 base pairs.

After selecting the location unit 160b, in the embodiment of FIG. 7, the user selects a genome assembly version 160f. The genome assembly version 160f represents versions of the human genome as they have been amended to place genes into context along the DNA strand. The genomic coordinate system of a gene in a genome assembly may be different from that of the same gene in another assembly. In one embodiment, as shown in FIG. 7, the four most recent genome assembly versions 160g-j are given as options for the user to select, using a radial button. The user may select the appropriate genome assembly version 160g-j to match the coordinate structure under which the gene information, in this case the first and second genomic coordinates 154 and 156, respectively, of the at least one ROH 152 were obtained.

After selecting the appropriate genome assembly version 160f, the user may then select a query type 160k which specifies the type of data that is input into the data entry field 160a. In the embodiment shown in FIG. 7, the user may select either a ROH query 160l or a microdeletion/microduplication query 160m. However, it should be understood that the type of data could also be an exome array, which can be the complete set of protein-coding genes. The exome array can be contained in a file which may be uploaded to the host system 102 by the user terminal 104.

After selecting the query type 160k, the user may elect a search criterion 160n. The search criterion 160n represents a categorization of genes and a methodology by which the processor 158b constrains the search of any of the preloaded genetic databases. In the embodiment shown in FIG. 7, the user may select an all genes radial button 160o, an OMIM genes radial button 160p, an OMIM genes with disorders radial button 160q, an OMIM genes with dominant inheritance pattern radial button 160r, an OMIM genes with recessive inheritance pattern radial button 160s, a Cosmic cancer genes radial button 160t, or a your gene list radial button 160u. Selection of the Cosmic cancer genes radial button 160t helps to determine evaluating results of a microarray done on tumor tissue in which genes associated with a particular type of cancer are deleted (or duplicated). When the cosmic cancer genes radial button 160t is selected, the host system 102 forms a query to search one or more genetic database linked to particular phenotypic information describing types of cancer. For example, a suitable genetic database is titled “Catalogue Of Somatic Mutations In Cancer” and can be accessed using the following link http://www.sanger.ac.uk/genetics/CGP/cosmic/.

The radial button 160u can be selected and used when the user is curious about the presence of certain genes on the query ROHs. Upon receipt of a signal indicating selection of the radial button 160u, the host system 102 preferably generates a text box (not shown) for receipt of one or more gene id or a gene symbol to search whether the interested genes present on the query ROHs. This could include genes of special interest to the user, eg. there are ˜42 retinitis pigmentosa genes, so a researcher interested in RP may have these genes in a text file, and can enter this list into the text box

The all genes radial button 160o denotes a search for all genes, within the chromosome range specified by the first and second genomic coordinates 154 and 156, respectively, and within any of the preloaded genetic databases. The OMIM genes radial button 160p denotes a search for all genes within the preloaded OMIM genetic database 128a and within the chromosome range specified by the first and second genomic coordinates 154 and 156, respectively. The OMIM genes with disorders radial button 160q denotes a search for all genes associated with disorders within the preloaded OMIM genetic database 128a and within the chromosome range specified by the first and second genomic coordinates 154 and 156, respectively. The OMIM genes with dominant inheritance patterns radial button 160r denotes a search for all genes within the preloaded OMIM genetic database 128a associated with dominant inheritance patterns and within the chromosome range specified by the first and second genomic coordinates 154 and 156, respectively. The OMIM genes with recessive inheritance pattern radial button 160s denotes a search for all genes within the OMIM genetic database 128a associated with recessive inheritance patterns and within the chromosome range specified by the first and second genomic coordinates 154 and 156, respectively. The cosmic cancer genes radial button 160t denotes a search for all genes within the chromosome range specified by the first and second genomic coordinates 154 and 156, respectively, which are associated with cancer and within the preloaded Catalogue of Somatic Mutations in Cancer (COSMIC) database. The your gene list radial button 160u denotes a search for genes specified by the researcher within the chromosome range specified by the first and second genomic coordinates 154 and 156, respectively. In some instances (eg. In consanguinity, the user will be especially interested in genes causing AR (recessive) disorders, while in other instances (eg. In deletions) the user will be especially interested in AD (dominant) genes. Also, sometimes the clinical synopsis is poorly annotated, and it maybe best to look for ‘all genes’.

After selecting the search 160n, the user may further select options further filtering the search results. If the user selects one of the plurality of OMIM searches 160p-160s, the user may further select a Human Phenotype Ontology (HPO) phenotype radial button 160v or a specific clinical features radial button 160w. The HPO phenotype radial button 160v filters the search 160n, within the preloaded OMIM genetic database 128a and within the chromosome range specified by the first and second genomic coordinates 154 and 156, respectively, with a standardized vocabulary of phenotypic abnormalities. The specific clinical features radial button 160w filters the search 160n, within the preloaded OMIM genetic database 128a and within the chromosome range specified by the first and second genomic coordinates 154 and 156, respectively, with key words chosen by the user to describe specific observed phenotypic features of the patient.

When the user selects the HPO phenotype radial button 160v, the bioinformatics search tool system 100 generates a data entry field 160x and an HPO phenotype window 162. Within the HPO phenotype window 162, the bioinformatics search tool system 100 generates a floating data entry window 164, which may be provided as one or more html pages. The floating data entry window 164 can be moved around to provide the best view of HPO phenotype window 162, generated by the bioinformatics search tool system 100 for ease of data entry. In the embodiment shown in FIGS. 7A-7C, the floating data entry window 164 is generated with data entry field 164a; a plurality of Boolean term buttons 164b-164d; bracket buttons 164e and 164f; data entry field manipulation buttons, Finish 164g, Remove All 164h, and Remove Last 164i; HPO phenotype window manipulation buttons, Unfold HPO Phenotypes 164j, Fold HPO Phenotypes 164k, and Go to top 164l; and a selected definition field 164m.

The bioinformatics search tool system 100 may generate the HPO phenotype window 162 as a hierarchical tree structure for a standardized vocabulary of phenotypic abnormalities encountered in human disease. The HPO phenotype window 162 can be generated by the bioinformatics search tool system 100 from a preloaded HPO database (not shown). In this embodiment, initially all HPO phenotypes are folded into a single HPO phenotype, and the user opens the HPO hierarchical ontology by clicking the Unfold HPO Phenotypes 164j button, and then collapses the clicking ontology by selecting the Fold HPO Phenotypes 164k button. Once open, the user may then locate the phenotypic vocabulary within the hierarchical ontology to further delimit the search 160n. Once the user has located the phenotypic vocabulary items desired, the user may click and drag those terms and their hierarchical codes into the data entry field 164a. The phenotypic vocabulary items transferred into the data entry field 164a by the user are then displayed by the bioinformatics search tool system 100 in the selected definition field 164m along with their hierarchical codes. Once the user has located the phenotypic vocabulary desired, the user may use the bracket buttons 164e and 164f and the Boolean term buttons 164b-164d to create a complex Boolean search by the selected phenotypic vocabulary items selected. The user may then remove some or all of the selected phenotypic vocabulary items by clicking the Remove Last 164i or Remove All 164h buttons, in order to reassemble a HPO query string. When the user has finished selecting the desired phenotypic vocabulary items, the user clicks the Finish 164g button. Upon clicking the Finish 164g button, the bioinformatics search tool system 100 minimizes the HPO phenotype window 162 and populates the data entry field 160x with the user input from data entry field 164a. In another embodiment, the data entry field 160x can be provided with logic that searches for HPO terms in the HPO database as a user types characters or words into the date entry field 160x. The logic causes the located HPO terms to be visually displayed or depicted on the screen in a drop down list, for example. In this instance, the user can select one or more of the HPO terms in the drop down list to populate the data entry field 160x. Multiple terms can be selected by using any suitable logic to identify the multiple terms, such as a suitable keyboard input, (e.g., SHIFT or CONTROL) in combination with a mouse-click, for example. In one embodiment, the HPO database can be a hierarchical database in which terms ‘above’ an entered search term can be visualized by ‘mousing over’ the term. If desired, the user can then pick a term in the hierarchy, knowing that such term is less specific, but also more inclusive.

The bioinformatics search tool logic, when a search is initiated with the first and second genomic coordinates 154 and 156, respectively, from the at least one ROH 152, allows the user to select search criteria with which to query the one or more genetic database 128. In the embodiment shown in FIG. 4, four searches are performed by the bioinformatics search tool system 100, each listing the results from the individual search. The all genes search 166 corresponds to a search selecting the all genes radial button 160o. The OMIM genes search 168 corresponds to a search selecting the OMIM genes radial button 160p. The morbid genes search 170 corresponds to a search selecting the OMIM genes with disorders radial button 160q. The AR morbid genes search 172 corresponds to a search selecting the OMIM genes with recessive inheritance pattern radial button 160s. The OMIM clinical synopsis search 174 corresponds to a search selecting one of the OMIM searches 160p-160s and additionally selecting the special clinical features radial button 160w. When the first and second genomic coordinates 154 and 156, respectively, are input into the bioinformatics search tool system 100, the bioinformatics search tool logic causes the processor 108 to access the one or more genetic database(s) 128 via the network 106. The processor 108 queries the one or more genetic database(s) 128 given the search criteria selected by the user, which may include a combination of selections from drag and drop menus, radial button selections, and/or keyword searches. In an embodiment of the bioinformatics search tool system 100, the results acquired from the search of the one or more genetic database(s) 128 may narrow the genes information from the at least one ROH 152 to a set of genes which have been identified by the one or more genetic database(s) 128. The results from the search of the one or more genetic database(s) 128 may be output in a data structure, such as a tab delimited text file, an Excel Spreadsheet file, or any other suitable means. The bioinformatics search tool system 100 may save the results of each search of the at least one ROH 152 in memory 110 into a gene list 176-184. As shown in FIG. 4, the gene list 176 results from the all genes search 166, the gene list 178 results from the OMIM genes search 168, the gene list 180 results from the morbid genes search 170, the gene list 182 results from the AR morbid genes search 172, and the gene list 184 results from the OMIM clinical synopsis search 174.

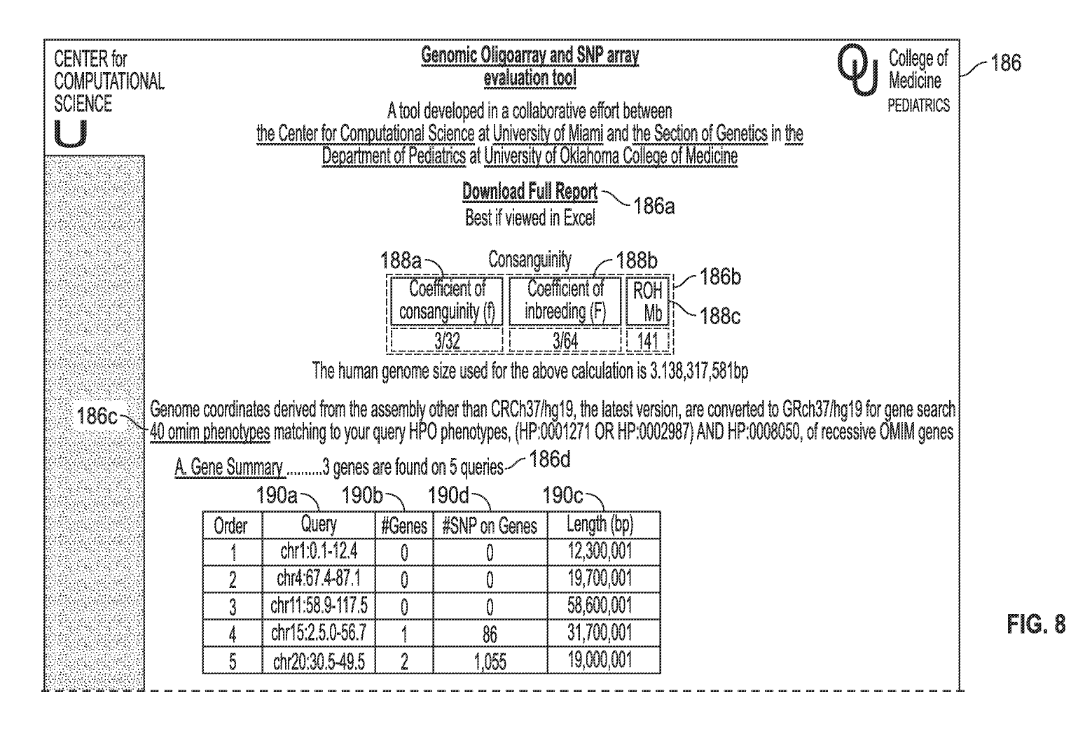

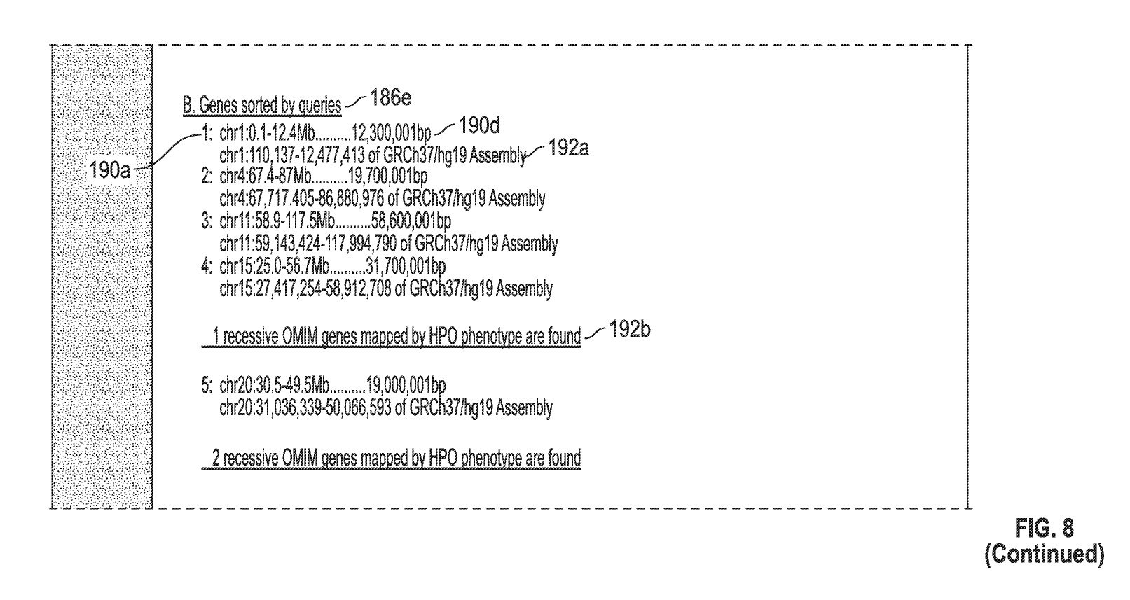

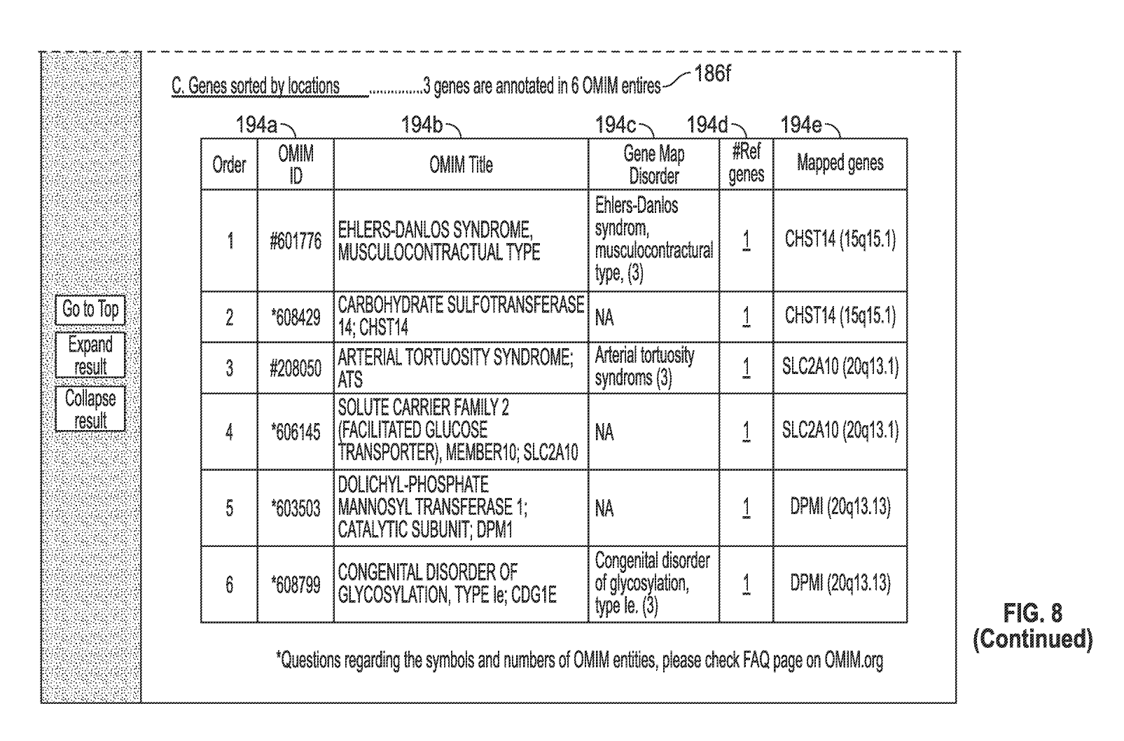

Referring now to FIG. 8, shown therein is an embodiment of a results set 186 which can be implemented in a variety of manners, such as fixed (e.g., text file) or dynamic (e.g., web page, or application file with links to external information). For example, the bioinformatics search tool system 100 may display a webpage with the results set 186. Within the result set 186 webpage may be displayed a link to a downloadable full report 186a. The downloadable full report 186a may take the form of an Excel spread sheet, a text file, a tab delimited text file, or any other suitable file. In addition to the downloadable full report 186a, the bioinformatics search tool system 100 may display a consanguinity report 186b, an OMIM phenotype match 186c, a gene summary 186d, a genes sorted by queries 186e, and a genes sorted by locations 186f.

The consanguinity report 186b may show the coefficient of consanguinity 188a, a coefficient of inbreeding 188b, and a ROH size 188c. The coefficient of consanguinity 188a, often abbreviated “f,” is the probability that two individuals who mated and had offspring, the offspring would be homozygous for a specific gene due to consanguinity. The coefficient of inbreeding 188b, often abbreviated “F,” is the probability that an individual will be homozygous for a particular gene, and is the coefficient of consanguinity of the individual's parents.

The OMIM phenotype match 186c may show the number of OMIM phenotypes matched by the HPO phenotypic vocabulary items employed by the user after selecting the HPO phenotype radial button 160v. The OMIM phenotype match 186c may also contain a link to the online OMIM database containing a list of the OMIM phenotypes matched by the phenotypic vocabulary items.

The gene summary 186d may contain, but is not limited to query information 190a, a number of identified genes 190b, a number of SNP on genes 190c, and a ROH length 190d. The query information 190a may be comprised of the first and second genomic coordinates 154 and 156, respectively, entered into the initial search by the user. The number of identified genes 190b may be the number of genes identified within a given ROH which have been identified as of interest by the bioinformatics search tool system 100. The ROH length 190d may refer to the distance in base pairs between the first and second genomic coordinates 154 and 156, respectively. The results set 186 may be configured to permit a user to click on a link to open a list of identified genes on a given ROH

The genes sorted by queries 186e may contain but is not limited to the query information 190a, the ROH length 190d, a gene assembly version mapping 192a, and number of genes identified on the ROH link 192b. The gene assembly version mapping 192a identifies the gene listed in the query information 190a, mapping that queried gene to the most recent gene assembly version. The number of genes identified on the ROH link 192b, when selected causes the bioinformatics search tool system 100 to open the list of identified genes on the at least one ROH 152.

The genes sorted by locations 186f may contain, but is not limited to, a gene database identification number 194a, a disorder title 194b, a gene map disorder 194c, a number of reference genes 194d, and a mapped gene(s) 194e. The gene database identification number 194a may contain information comprising a reference number, or official symbol, for a queried gene. The disorder title 194b may contain information comprising the title used by the one or more gene database(s) 128 of disorders related to a gene on the at least one ROH 152 queried. The gene map disorder 194c may identify the name of the disease. The number of reference genes 194d may list the number of genes associated with the disorder, as disorders may be caused by mutations in one of a number of genes. The mapped gene(s) 194e may identify the genes detected on the at least one ROH 152 which belong to a given gene database official symbol, and may also contain the Cytogenetic chromosomal location of for each gene identified.

Thus, it can be seen that the bioinformatics search tool system 100 can automatically retrieve pertinent information of genes located in a query of genomic regions, which may include runs of homozygosity (ROH). The pertinent information of genes preferably include gene location, gene id, gene official symbol, gene transcriptions, OMIM databases ID, OMIM syndrome and the like. The results discussed herein can be retrieved from several public sources/databases, such as NCBI gene_info, NCBI gene2refseq, OMIM genemap, OMIM mim2gene, OMIM morbidmap, OMIM omim.txt, Sanger Decipher syndromes, and the results may be downloaded and installed on a local hard drive of the user terminal 104. The results are preferably summarized for each gene, with emphasis on the genes associated with known disorders.

From the above description, it is clear that the inventive concept(s) disclosed herein is adapted to carry out the objects and to attain the advantages mentioned herein as well as those inherent in the inventive concept(s) disclosed herein. While presently preferred embodiments of the inventive concept(s) disclosed herein have been described for purposes of this disclosure, it will be understood that numerous changes may be made which will readily suggest themselves to those skilled in the art and which are accomplished within the scope and spirit of the inventive concept(s) disclosed herein and defined by the appended claims.

What is claimed is:

1. A computer system, comprising:
a processor;
a non-transitory memory storing processor executable code to cause the processor to:
receive data indicative of genetic array from a patient representative of at least one chromosomal segment identifying at least one gene(s),
receive phenotypic data indicative of at least one physical characteristic of a patient, and
query, using search criteria including the data indicative of the genetic array and the phenotypic data, one or more gene databases containing data on diseases associated with the one or more gene(s) within the chromosomal segment and return results comprising one or more gene(s) and one or more phenotypic indicators for disease(s) associated with the one or more gene(s) within the chromosomal segment, and
a communication system transmitting the results via a network using an internet protocol.

2. The computer system of claim 1, wherein the processor executable code causes the processor to provide a data entry field for receiving the data indicative of the genetic array.

3. The computer system of claim 1, wherein the processor executable code causes the processor to provide a location unit input field to receive information indicative of a specific base pair location unit, and wherein the search criteria includes the information indicative of the specific base pair location unit.

4. The computer system of claim 1, wherein the processor executable code causes the processor to provide a genome assembly version input field to specify a genome assembly version of the data indicative of genetic array, and wherein the search criteria includes the genome assembly version.

5. The computer system of claim 1, wherein the processor executable code causes the processor to provide a query type input field, and wherein the search criteria includes the query type.

6. The query type input field of claim 5, wherein the query type is a query of runs of homozygosity.

7. The query type input field of claim 5, wherein the query type is a query of a microdeletion.

8. The query type input field of claim 5, wherein the query type is a query of a microduplication.

9. The computer system of claim 1, wherein the processor executable code causes the processor to provide a search type input field, and wherein the search criteria includes the search type.

10. The search type input field of claim 9, wherein the search type is a search for all genes within the at least one chromosomal segment.

11. The search type input field of claim 9, wherein the search type is a search for disorder associated genes within the at least one chromosomal segment.

12. The search type input field of claim 9, wherein the search type is a search for dominant inheritance pattern genes within the at least one chromosomal segment.

13. The search type input field of claim 9, wherein the search type is a search for recessive inheritance pattern genes within the at least one chromosomal segment.

14. The computer system of claim 1, wherein the processor executable code causes the processor to provide a data entry field for hierarchical phenotypic information, and wherein the search criteria include phenotypic information.

15. The computer system of claim 1, wherein the processor executable code causes the processor to provide a data entry field to receive clinical feature information, and wherein the search criteria include the clinical feature information.

16. A computer system, comprising:
a processor,
a communication system coupled to a network and communicating with one or more genetic databases using an internet protocol;
a non-transitory memory storing processor executable code to cause the processor to (1) receive data indicative of genetic array data of a patient via the communication system, (2) conduct, via the communication system and the network, at least one query of the one or more genetic databases of genotypic data and phenotypic data using the data indicative of patient genetic data and phenotypic data, and (3) provide results of the at least one query to provide a clinical synopsis of the patient.

17. A method, comprising the steps of:
receiving data indicative of at least a portion of a genetic array from a patient representative of at least one chromosomal segment identifying at least one gene(s);
receiving phenotypic data indicative of at least one physical characteristic of a patient;
querying one or more gene databases, using search criteria including the data indicative of the genetic array and the phenotypic data, the one or more gene databases containing data on diseases associated with the one or more gene(s) within the chromosomal segment;
returning a results set as one or more web pages comprising data indicative of one or more gene(s) and one or more phenotypic indicators for disease(s) associated with the one or more gene(s) within the chromosomal segment.

18. The method of claim 17, wherein the step of receiving phenotypic data includes the steps of generating a phenotype window having a standardized vocabulary of phenotypic abnormalities encountered in human disease.

19. The method of claim 18, wherein the standardized vocabulary is provided in a hierarchical format.
